(19) United States
(12) Patent Application Publication
(10) Pub. No.: US 2010/0047583 A1
(43) Pub. Date: Feb. 25, 2010

(54) AUTOMOTIVE SUBSTRATE HAVING A COATING LAYER SYSTEM WITH A BARRIER COATING COMPOSITION LAYER

(76) Inventors: Michelle S. MILES, Mercer, PA (US); Edward F. Rakiewicz, Gibsonia, PA (US); Ken W. Niederst, Allison Park, PA (US); Richard F. Karabin, Ruffs Dale, PA (US)

Correspondence Address: PPG INDUSTRIES INC;INTELLECTUAL PROPERTY DEPT, ONE PPG PLACE, PITTSBURGH, PA, 15272, US

(21) Appl. No.: 12/194,991

(22) Filed: Aug. 20, 2008

(51) Int. Cl. B32B 27/38; C25D 5/48

(52) U.S. Cl. 428/413; 205/80

(57) ABSTRACT

An automotive substrate comprising an electrodepositable coating layer deposited over at least a portion of the automotive substrate and a barrier coating layer deposited over at least a portion of the electrodepositable coating layer.

### BACKGROUND OF THE INVENTION

1. Field of the Invention

The present invention relates to an automotive substrate comprising an electrodeposited coating layer and a barrier coating layer.

2. Background Information

A conventional automotive substrate typically includes a number of sequential coating compositions layers (collectively, referred to as a coating system) which are deposited onto the automotive substrate.

The first coating layer that is applied onto the automotive substrate is typically an electrodeposited coating layer. Deposited over at least a portion of the electrodepositable coating layer is a primer coating layer. Deposited over at least a portion of the primer coating layer is a basecoat coating layer. Finally, a substantially clear coating layer is deposited over at least a portion of the basecoat coating layer.

Despite the multiple layers that are deposited onto an automotive substrate, the automotive substrate can be susceptible to corrosion, such as filiform corrosion, if one or more of the coating layers is compromised (i.e., damaged).

### SUMMARY OF THE INVENTION

The present invention is directed to an automotive substrate comprising an electrodepositable coating layer deposited over at least a portion of the automotive substrate, and a barrier coating layer deposited over at least a portion of the electrodepositable coating layer.

The present invention is also directed to an automotive substrate comprising an electrodeposited coating layer deposited over at least a portion of the automotive substrate; and a barrier coating layer deposited over at least a portion of the electrodepositable coating layer wherein the barrier coating layer comprises the reaction product of a polyamine component and a polyepoxide.

The present invention is further directed to an automotive substrate comprising an electrodeposited coating layer deposited over at least a portion of the automotive substrate; and a barrier coating layer deposited over at least a portion of the electrodepositable coating layer wherein the barrier coating layer comprises the reaction product of a polyepoxide and a citric acid.

The present invention is further directed to a method for coating a substrate comprising: applying an electrodepositable coating composition onto at least a portion of the substrate; substantially curing the electrodepositable coating composition to form an electrodepositable coating layer; applying a barrier coating composition onto at least a portion of the electrodepositable coating layer, the barrier coating composition comprising the reaction product of a polyamine component and a polyepoxide; and substantially curing the barrier coating composition to form a barrier coating layer.

### DETAILED DESCRIPTION OF THE INVENTION

As used herein, unless otherwise expressly specified, all numbers such as those expressing values, ranges, amounts or percentages may be read as if prefaced by the word “about”, even if the term does not expressly appear. Plural encompasses singular and vice versa. For example, although reference is made herein to “a” barrier coating composition layer, “an” electrocoat coating composition layer, “a” primer-surfacer coating layer, “a” barrier coating layer, “a” substantially clear coating layer, a combination (i.e, a plurality) of any of these layers can be used.

As used herein, “plurality” means two or more.

As used herein, “includes” and like terms means “including without limitation.”

As used herein, the term “cure” refers to a coating wherein any crosslinkable components of the composition are at least partially crosslinked. In certain embodiments, the crosslink density of the crosslinkable components (i.e., the degree of crosslinking) ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

When referring to any numerical range of values, such ranges are understood to include each and every number and/or fraction between the stated range minimum and maximum.

It will be understood that the various coating layers that are described herein are deposited from a coating composition. For example, the barrier coating layer is deposited from a barrier coating composition.

### Barrier Coating Layer

The present invention is directed to an automotive substrate that comprises an electrodepositable coating layer and a barrier coating layer deposited over at least a portion of the electrodepositable coating layer. As used herein, a “barrier coating layer” refers to a coating layer that is substantially impermeable to oxygen and/or water. As used herein, “substantially impermeable to oxygen” means that the barrier coating has a permeation coefficient for oxygen of <1 cc-mil/100 in²-atm-day at 23° C. at 95%-100% relative humidity. As used herein, “substantially impermeable to water” means that the barrier coating has a permeation coefficient for water vapor of <2 gram-mil/100 in²-day at 23° C. at 95%-100% relative humidity. It will be noted that these measurements were taken by subjecting one side of the barrier coating layer to 95%-100% relative humidity while allowing the other side of the barrier coating to remain at 0% relative humidity.

One advantage that can be derived from utilizing the aforementioned barrier coating layer on an automotive substrate is that it can aid in corrosion prevention when one or more layers of the coating system that is applied onto the automotive substrate are damaged.

The barrier coating layer can comprise the reaction product of: (i) a polyepoxide and a polyamine component; (ii) a polyepoxide and a mannich base component; (iii) a polyepoxide and a polyacid; (iv) or combinations thereof. In certain embodiments, the barrier coating layer can consist essentially of or consists of the reaction product of (i), (ii), and/or (iii).

Suitable polyepoxides that can be used to form the barrier coating layer include, without limitation, bisphenol A, F based epoxies derived from bisphenol A, F and epichlorohydrin (e.g., EPON 828 and 1001, which are commercially available from Shell(Hexion)), hydrogenated bisphenol A based epoxies (e.g., EPON 1510, which is commercially available from Shell(Hexion)), novolak epoxies (e.g., DEN-431, DEN-438, DEN-439, which are commercially available from Dow Chemical Co.), resorcinol based epoxies such as resorcinol diglycidyl ether (e.g., Erisys RDGE-H, which is commercially available from CVC Corp.), aliphatic epoxies (e.g., DER 736 and 732, which are commercially available from Dow Chemical, EPON 812, which is commercially available from Shell(Hexion), RD-2, which is commercially available from CVD Corp.), cycloaliphatic epoxies (e.g., ERL-4221 and 4206, which are commercially available from Ciba-Geigy Corp.), epoxidized oils (e.g., epoxidized soybean oil, castor oil based epoxies), glycidyl esters (e.g., BLEMMER DGT, which is commercially available from Nippon Oil and Fat Co.), epoxies derived from amines and epichlorohydrin such as N,N,N′,N′-tetraglycidyl-meta-xylylenendiamine (e.g., TETRAD X, which is commercially available from Mitsubishi Chemical), or combinations thereof.

The polyamine component used to form the barrier coating layer can include, without limitation, a polyamine, a polyamine adduct, the ethylene amine series of polyamines having the formula NH₂—CH₂—CH₂—[NH—CH₂—CH₂—]ₓ—NH₂, where x=0-3, or combinations thereof.

Suitable polyamines that can be used as the polyamine component include, without limitation, xylene diamines and their reaction products with epichlorohydrin (e.g., Gaskamine 328S, which is commercially available from Mitsubishi Gas Chemical), phenylene diamines, alicyclic diamines (e.g., isophorone diamine, piperazine, piperidine), aromatic amines (e.g., methylene dianiline, o-phenylene diamine, p-phenylene diamine), cycloaliphatic amines (e.g., isophorone diamine), or combinations thereof.

When a polyamine adduct is used as the polyamine component, the polyamine adduct can be the reaction product of a polyamine and another component. Suitable polyamines that can be used to form the polyamine adduct include those listed above as well as polyamines that have substantial aromatic content. As used herein, “substantial aromatic content” means at least 50% of the carbon atoms in the polyamine are in aromatic rings, including fused aromatic rings (i.e., phenylene groups and/or napthylene groups). In certain embodiments, an amine group of an aromatic amine is attached directly to the aromatic group, or an amino group can be attached to the aromatic group via an alkyl group (e.g., a methylene group). In certain embodiments, when the aromatic group is phenylene, the polyamine can comprise xylylenediamine, meta-xylylenediamine, or combinations thereof.

The other component with which the polyamine is reacted in order to form the polyamine adduct include, without limitation, epichlorohydrin, a polyepoxide, the reaction product of formaldehyde and phenol, or combinations thereof. Suitable polyepoxides include those listed above as well as a bisphenol F epoxy resin (e.g., EPALLOY 8220 or 8230, which are commercially available from CVC Corp.), 1,4 butanediol diglycidyl ether (e.g., Erisys GE-21, which is commercially available from CVC Corp.), or combinations thereof.

Suitable mannich bases that can be used as the mannich base component used to form the barrier coating layer include, without limitation, amines (such as the polyamines described above), formaldehydes, phenols, or combinations thereof.

Suitable polyacids that can be used to form the barrier coating layer include, without limitation, citric acid such as phosphoric acid, tartaric acid, or combinations thereof. In some embodiments, the barrier coating layer comprises the reaction product of TETRAD X with citric acid.

### Coating System

As stated above, the present invention is directed to an automotive substrate comprising an electrodeposited coating layer and a barrier coating layer deposited over at least a portion of the electrodeposited coating layer.

Suitable automotive substrates that can be used with the present invention include, without limitation, metal substrates, metal alloy substrates, and/or substrates that has been metallized, such as nickel plated plastic. In some embodiments, the metal or metal alloy can be aluminum and/or steel. For example, the steel substrate could be cold rolled steel, electrogalvanized steel, and hot dipped galvanized steel. Moreover, in some embodiments, the substrate may comprise a portion of a vehicle such as a vehicular body (e.g., without limitation, door, body panel, trunk deck lid, roof panel, hood, and/or roof) and/or a vehicular frame. As used herein, “vehicle” or variations thereof includes, but is not limited to, civilian, commercial, and military land vehicles such as cars, motorcycles, and trucks. It will also be understood that, in some embodiments, the substrate may be pretreated with a pretreatment solution, such as a zinc phosphate solution as described in U.S. Pat. Nos. 4,793,867 and 5,588,989, which are incorporated herein by reference, or not pretreated with a pretreatment solution. It should be noted that “automotive substrate” explicitly excludes plastic containers (e.g., plastic bottles) as well the plastic caps or closures that are used on such plastic containers.

For clarity, when referring to an “automotive substrate” herein, it should be noted that the substrate may or may not be pretreated and/or may or may not have an electrodepositable coating.

The electrodeposited coating layer is deposited over at least a portion of the automotive substrate. It will be appreciated that the electrodeposited coating layer can be deposited from any anionic or cationic electrodepositable coating composition that is known in the art. In certain embodiments, the electrodepositable coating composition described in U.S. patent application Ser. No. 11/835,600, which is incorporated herein in its entirety by reference, can be used in the coating system. It will be appreciated that, in some embodiments, the electrodepositable coating composition is cured prior to the application of a barrier layer coating composition onto the automotive substrate.

The barrier coating layer can be deposited from a barrier coating composition which comprises the reaction ingredients described above. The barrier coating composition is deposited over at least a portion of the electrodeposited coating layer that is described in the preceding paragraph.

In certain embodiments, a primer surfacer coating layer is deposited over at least a portion of the barrier coating layer. It will be appreciated that the primer coating layer can be deposited from any primer coating composition that is known in the art. For example, in certain embodiments, the primer coating composition that is described in U.S. patent application Ser. No. 11/773,482, which is incorporated in its entirety herein by reference, can be used in the coating system. However, it should be noted that in some embodiments, the coating system that is applied onto the automotive substrate lacks the primer surfacer coating layer.

In some embodiments, a color imparting (basecoat) coating layer is deposited onto at least a portion of the primer surfacer coating layer (if present) or onto at least a portion of the barrier coating layer (if the primer surfacer coating layer is not present). It will be appreciated that the basecoat coating layer can be deposited from any basecoat coating composition known in the art.

In certain embodiments, a substantially clear coating layer (clearcoat) is deposited onto at least a portion of the basecoat coating layer. As used herein, a “substantially clear” coating layer is substantially transparent and not opaque. In certain embodiments, the substantially clear coating layer can comprise a colorant but not in an amount such as to render the clear coating layer opaque (not substantially transparent). The clearcoat layer can be deposited from any clearcoat coating composition known in the art. For example, the clearcoat coating composition that is described in U.S. Pat. No. 6,387,519 B1, which is incorporated in its entirety herein by reference, can be used in the coating system. In certain embodiments, the substantially clear coating layer can also comprise a particle, such as a silica particle, that is dispersed in the clearcoat coating layer (such as at the surface of the clearcoat coating layer).

In certain embodiments, the barrier coating layer is not disposed between the electrodepositable coating layer and the primer surfacer coating layer. That is, in certain embodiments, the barrier coating layer is positioned elsewhere in the coating layer system. For example, the barrier coating layer can be disposed between the primer surfacer coating layer and the basecoat coating layer.

It should be noted that the coating compositions that form one or more of the various coating layers described herein may be a water-based or solvent-based liquid composition, or, alternatively, may be in solid particulate form (i.e., a powder coating. Additionally, the coating compositions can comprise (1) one or more film-forming polymers having reactive functional groups, and, optionally, (2) a curing agent (crosslinking agent) that is reactive with the reactive functional groups of the film-forming polymer. One skilled in the art would appreciate that a curing agent would not be required if the reactive functional groups of the film-forming polymer are reactive with themselves (self-crosslinking).

The film-forming polymer described herein can be selected from, for example, acrylic polymers, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. Such polymers may be solvent borne or water dispersible, emulsifiable, or of limited water solubility. The functional groups on the film-forming resin may be selected from any of a variety of reactive functional groups including, without limitation, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

Suitable curing agents include, without limitation, aminoplasts, polyisocyanates (including blocked isocyanates), polyepoxides, beta-hydroxyalkylamides, polyacids, anhydrides, organometallic acid-functional materials, polyamines, polyamides, and mixtures of any of the foregoing.

It will be further appreciated that the coating compositions that form the various coating layers described herein can be either “one component” (“1K”), “two component” (“2K”), or even multi-component compositions. A 1K composition will be understood as referring to a composition wherein all of the coating components are maintained in the same container after manufacture, during storage, etc. A 1K coating can be applied to a substrate and cured by any conventional means, such as by heating, forced air, and the like. The present coatings can also be 2K coatings or multi-component coatings, which will be understood as coating in which various components are maintained separately until just prior to application.

In certain embodiments, the coating compositions that form the coating layers described herein can include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating composition described herein.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating composition described herein. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions can comprise other optional materials well known in the art of formulated surface coatings, such as plasticizers, anti-oxidants, hindered amine light stabilizers, UV light absorbers and stabilizers, surfactants, flow control agents, thixotropic agents such as bentonite clay, pigments, fillers, organic cosolvents, catalysts, including phosphonic acids and other customary auxiliaries.

The coating compositions that form the various coating layers described herein can be deposited or applied onto the substrate using any technique that is known in the art. For example, the coating compositions can be applied to the substrate by any of a variety of methods including, without limitation, spraying, brushing, dipping, and/or roll coating, among other methods. When a plurality of coating compositions are applied onto a substrate, it should be noted that one coating composition may be applied onto at least a portion of an underlying coating composition either after the underlying coating composition has been cured or prior to the underlying coating composition being cured. If the coating composition is applied onto an underlying coating composition that has not been cured, both coating compositions may be cured simultaneously.

The coating compositions may be cured using any technique that is known in the art. For example, the coating composition may be cured using curing methods including, but not limited to, thermal energy, infrared, ionizing or actinic radiation, or by any combination thereof. In certain embodiments, the curing operation can be carried out at temperatures ≧10° C. In other embodiments, the curing operation can be carried out at temperature ≦246° C. In certain embodiments, the curing operation can carried out at temperatures ranging between any combination of values, which were recited in the preceding sentences, inclusive of the recited values. For example, the curing operation can be carried out at temperatures ranging from 121.1° C.-148.9° C. It should be noted, however, that lower or higher temperatures may be used as necessary to activate the curing mechanisms.

In certain embodiments, the coating compositions described herein is a low temperature, moisture curable coating compositions. As used herein, the term “low temperature, moisture curable” refers to coating compositions that, following application to a substrate, are capable of curing in the presence of ambient air, the air having a relative humidity of 10% to 100%, such as 25% to 80%, and a temperature in the range of −10° C. to 120° C., such as 5° C. to 80° C., in some cases 10° C. to 60° C. and, in yet other cases, 15° C. to 40° C.

The dry film thickness of the coatings that result from the various coating compositions can range from 0.1 micron to 500 microns. In other embodiments, the dry film thickness can be ≦125 microns, such as ≦80 microns. For example, the dry film thickness can range from 15 microns to 60 microns.

It will also be understood that in certain embodiments of the coating system, subsequent coating layers may be applied onto an underlying layer despite the fact that the underlying layer has not been fully cured. For example, a clearcoat coating composition may be applied onto the basecoat coating composition even though the basecoat coating composition has not been subjected to a curing or flashing step. Both layers can then be cured during a subsequent curing step thereby eliminating the need to cure each layer separately.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

### EXAMPLES

### Panel 1:

A phosphated steel panel containing a chrome rinse which is commercially available from ACT as C700 C59 CRS was electrocoated with ED 6100 H which is commercially available from PPG Industries, Inc. The panel was coated at 92° F./200 volts/42 coulombs to give a dry film thickness of approximately 0.90 mils after curing at 350° F. for 25 minutes.

### Panel 2:

A panel as described in Example 1 was coated with the following barrier coating composition:

| | Weight (grams) |
|---|---|
| Component A | |
| Gaskamine | 12.76 |
| 328S¹ | |
| SEK-3838 | 5.05 |
| SF 1023 | 0.02 |
| Component B | |
| Tetrad X¹ | 14.18 |
| DEN431² | 6.05 |

¹Commercially available from Mitsubishi Gas Chemical.
²Commercially available from Dow Chemical.

The ingredients of Component A and Component B were mixed together and the barrier coating composition was then spray applied onto the panel and cured at 325° F. for 30 minutes to give a dry film thickness of 0.80 mils.

### Top Coating on Panels 1 and 2

Panels 1 and 2 were each topcoated with the following layers:
Primer Surfacer: Each panel was coated with HPX1709³ and subjected to a 10 minute flash process at ambient air temperatures. After the flash process, each panel was baked for 30 minutes at 284° F. The dry film thickness of the resulting layer ranged from 1.6 mil to 1.8 mil.
Basecoat: Each panel was coated with OHDCTB95238³, which was applied in two coats, and subjected to a 2 minute flash process at ambient air temperatures. The dry film thickness of the resulting layer ranged from 0.7 mil to 0.9 mil.
Clearcoat: Each panel was then coated with CHDCT4010M³, which was applied in two coats, and subjected to a 7 minute flash process at ambient air temperatures. After the flash process, each panel was baked for 30 minutes at 284° F. The dry film thickness of the resulting layer ranged from 1.4 mil to 1.6 mil. ³Commercially available from PPG Industries, Inc.

### Exposure Testing

Panels 1 and 2 were then scribed to metal and submitted for 12 month exposure testing. The panels were exposed facing South at 5° for 12 months at Sunrise, Fla. Following the 12 month period, Panel 2 exhibited no filiform corrosion whereas Panel 1 showed filiform corrosion. Specific results are listed as follows:

TABLE 1

| Panel | Average Scribe Creep | Maximum Scribe Creep | Filiform |
|---|---|---|---|
| Panel 1 | 4 millimeters | 8 millimeters | Yes |
| (Control) | | | |
| Panel 2 | 1 millimeter | 2 millimeters | No |
| (Barrier) | | | |

What is claimed is:

1. An automotive substrate comprising:
an electrodeposited coating layer deposited over at least a portion of said automotive substrate; and
a barrier coating layer deposited over at least a portion of said electrodepositable coating layer.

2. The automotive substrate according to claim 1, further comprising a primer surfacer coating layer deposited over at least a portion of said barrier coating layer.

3. The automotive substrate according to claim 2, further comprising a basecoat coating layer deposited over at least a portion of said primer surfacer coating layer.

4. The automotive substrate according to claim 3, further comprising a clearcoat coating layer deposited over at least a portion of said basecoat coating layer.

5. The automotive substrate according to claim 1, wherein said barrier coating layer comprises the reaction product of a polyamine component and a polyepoxide.

6. The automotive substrate according to claim 5, wherein said polyamine component comprises the reaction product of a diamine and epichlorohydrin and said polyepoxide comprises N,N,N′,N′-tetraglycidyl-meta-xylylenendiamine and a novolac epoxy resin.

7. The automotive substrate according to claim 6, wherein said polyamine component is a monomeric polyamine, a polyamine adduct, or combinations thereof.

8. The automotive substrate according to claim 7, wherein said polyamine adduct is a reaction product of a polyamine and another component.

9. The automotive substrate according to claim 8, wherein said polyamine comprises polyamines having the formula NH₂—CH₂—CH₂—[NH—CH₂—CH₂—]ₓ—NH₂ where x=0-3.

10. The automotive substrate according to claim 8, wherein said polyamine comprises the reaction product of a xylene diamine with epichlorohydrin, a phenylene diamine, an alicyclic diamine, an aromatic amine, a cycloaliphatic amine, or combinations thereof.

11. The automotive substrate according to claim 8, wherein said another component comprises epichlorohydrin, a polyepoxide, a (meth)acrylate, the reaction product of phenol and (form)aldehyde, or combinations thereof.

12. The automotive substrate according to claim 8, wherein said another component comprises another polyepoxide, wherein said another polyepoxyide can be the same or different from the polyepoxide.

13. The automotive substrate according to claim 8, wherein said another component comprises the reaction product of formaldehyde and phenol.

14. The automotive substrate according to claim 1, wherein said barrier coating layer comprises a reaction product of a polyepoxide and a mannich base component.

15. The automotive substrate according to claim 14, wherein said mannich base component comprises an amine, a formaldehyde, a phenol, or combinations thereof.

16. The automotive substrate according to claim 1, wherein said barrier coating layer comprises a reaction product of a polyepoxide and a polyacid.

17. The automotive substrate according to claim 16, wherein said polyepoxide comprises N,N,N′,N′-tetraglycidyl-meta-xylylenendiamine and said polyacid is a citric acid.

18. An automotive substrate comprising:
an electrodeposited coating layer deposited over at least a portion of said automotive substrate; and
a barrier coating layer deposited over at least a portion of said electrodepositable coating layer wherein the barrier coating layer comprises the reaction product of a polyamine component and a polyepoxide.

19. The automotive substrate according to claim 18, wherein said polyamine component comprises the reaction product of a diamine and epichlorohydrin and said polyepoxide comprises N,N,N′,N′-tetraglycidyl-meta-xylylenendiamine and a novolac epoxy resin.

20. An automotive substrate comprising:
an electrodeposited coating layer deposited over at least a portion of said automotive substrate; and
a barrier coating layer deposited over at least a portion of said electrodepositable coating layer wherein the barrier coating layer comprises the reaction product of a polyepoxide and a citric acid.

21. The automotive substrate according to claim 20, wherein said polyepoxide comprises N,N,N′,N′-tetraglycidyl-meta-xylylenendiamine and said polyacid is a citric acid.

22. A method for coating a substrate comprising:
applying an electrodepositable coating composition onto at least a portion of said substrate;
substantially curing said electrodepositable coating composition to form an electrodepositable coating layer;
applying a barrier coating composition onto at least a portion of said electrodepositable coating layer, said barrier coating composition comprising the reaction product of a polyamine component and a polyepoxide; and
substantially curing said barrier coating composition to form a barrier coating layer.
